(19) United States
(12) Patent Application Publication
(10) Pub. No.: US 2012/0323681 A1
(43) Pub. Date: Dec. 20, 2012

(54) System for marketing and advertising through mobile electronic commerce

(76) Inventor: James Bercaw, Playa Del Rey, CA (US)

(21) Appl. No.: 13/134,880

(22) Filed: Jun. 20, 2011

(51) Int. Cl. G06Q 30/00

(52) U.S. Cl. 705/14.51

(57) ABSTRACT

The System includes a mobile application, a server-database, and a system website. The mobile application is executable on a user's smartphone.

In some preferred embodiments, the system may further comprise a plurality of server applications. These server applications may comprise a targeting application, an advertising application, a consumer application, a messaging application, and a merchant application.

### FIELD OF THE INVENTION

The present invention is in the area of mobile commerce, and more particularly pertains to systems and methods related to marketing strategies with respect to various services and products through mobile handsets.

### CROSS-REFERENCE

The present invention is hereby cross-referenced to the pending patent application by the same inventor, James Bercaw, entitled “A System for Mobile Electronic Commerce”.

### BACKGROUND OF THE INVENTION

One of the most capricious endeavors of marketing involves the process of advertising. The process of advertising is made difficult by a confluence of factors which renders its efficacy to be impossible to control. Various factors such as which medium to use, when to run various ads, where to place various ads, etc. are scientific disciplines unto themselves.

Unfortunately, the vagaries of advertising in a changing landscape of competition (e.g. social networking and the internet) can lead to boom and bust cycles. When executed to perfection, success can bring instant fame, higher margins, and plenty of backorders. By contrast, failed advertising campaigns can completely destroy a business overnight. A slight miscalculation in the timing in the placement of an ad can be all the difference to produce a boom or a bust.

However, in spite of all the moving parts which inhere with the process of advertising, there is one relative constant axiom when it comes to advertising: reach your target customer when they are ready to buy. Better yet, reach your target customer where and when they are in the process of buying.

This advertising principle is best demonstrated at movie theaters, sporting events, and conventions. For instance, a bucket of popcorn at a professional sporting event can yield a markup ten times greater than when purchased at a grocery store or at a restaurant. The venue operators have their intended customers at a controlled location, a specified time, and in a time duration when people are expected to be hungry or thirsty.

Along similar lines, impulse buying behavior is also another key focal point for strategic marketing. At many supermarkets, point of sale displays near the cashiers are displayed as people stand in line. These tempting candies and magazines owe their success to the impulsive purchasing behavior of consumers. Further, interactive promotional advertising increases instances of impulse purchasing opportunities.

With the foregoing factors in mind, new technologies are now in place to further take advantage of these marketing principles. For instance, experts say that smartphones will someday replace the wallet and credit card as the prime medium through which financial transactions take place, As such, businesses will be able to send precise targeted messages in the form of coupons, suggestive selling, upselling, etc to a customer who is ready to purchase, and better yet, is in the act of making a purchase.

As such, what is clearly needed in the market is a system to engage the consumer at time of purchase, to create demand and inform consumers via targeted coupons and other advertising using a person's smartphone. Such a system should enable advertisers to greatly reduce their advertising expense, and simultaneously drastically increase their effectiveness.

### SUMMARY OF THE INVENTION

It is an object of the present invention to provide a system and apparatus to enable merchants, marketing consultants, distributors, etc. to market their goods and services using an interactive process which engages the consumer. The process operates on a highly sophisticated network. This network operates through various networks including mobile handsets and websites.

### BRIEF DESCRIPTION OF THE DRAWING FIGURES

FIG. 1 is a block diagram of a preferred embodiment of the present invention.

FIG. 2 is a block diagram of a preferred embodiment of the present invention.

FIG. 3 is a block diagram of a preferred embodiment of the present invention.

FIG. 4 is a block diagram of a preferred embodiment of the present invention.

FIG. 5 is a block diagram of a preferred embodiment of the present invention.

FIG. 6 is a block diagram of a preferred embodiment of the present invention.

FIG. 7 is a block diagram of a preferred embodiment of the present invention.

FIG. 8 is a block diagram of a preferred embodiment of the present invention.

FIG. 9 is a block diagram of a preferred embodiment of the present invention.

FIG. 10 is a block diagram of a preferred embodiment of the present invention.

FIG. 11 is a block diagram of a preferred embodiment of the present invention.

FIG. 12 is a block diagram of a preferred embodiment of the present invention.

FIG. 13 is a block diagram of a preferred embodiment of the present invention.

### DESCRIPTION OF PREFERRED EMBODIMENTS

According to a preferred embodiment of the present invention, a unique System for Marketing and Advertising through Mobile Electronic Commerce 100 (alternately referred to as System 100) allows for easier transactions between consumers and merchants. Furthermore, the System 100 enables a variegated set of options for merchants to advertise their goods and services to potential consumers. Moreover, the present invention can be implemented to create demand, build brand loyalty, strengthen merchant-consumer goodwill, and increase up-sells. The present invention is described in enabling detail below.

For the purposes of the present invention, the terms “handset”, “smartphone”, cell phone, or other device are interchangeable. These devices should be able to execute a mobile application, send and receive short message service (hereafter “SMS”) text messages, establish an Internet connection, capture and display images with an integrated module (camera), and store memory.

For the purposes of the present invention, the term “Commerce Function” shall refer to an activity a demand which includes {a} commerce demand from the registered consumer, {b} commerce notification from the agent, or {c} a user accessing the system.

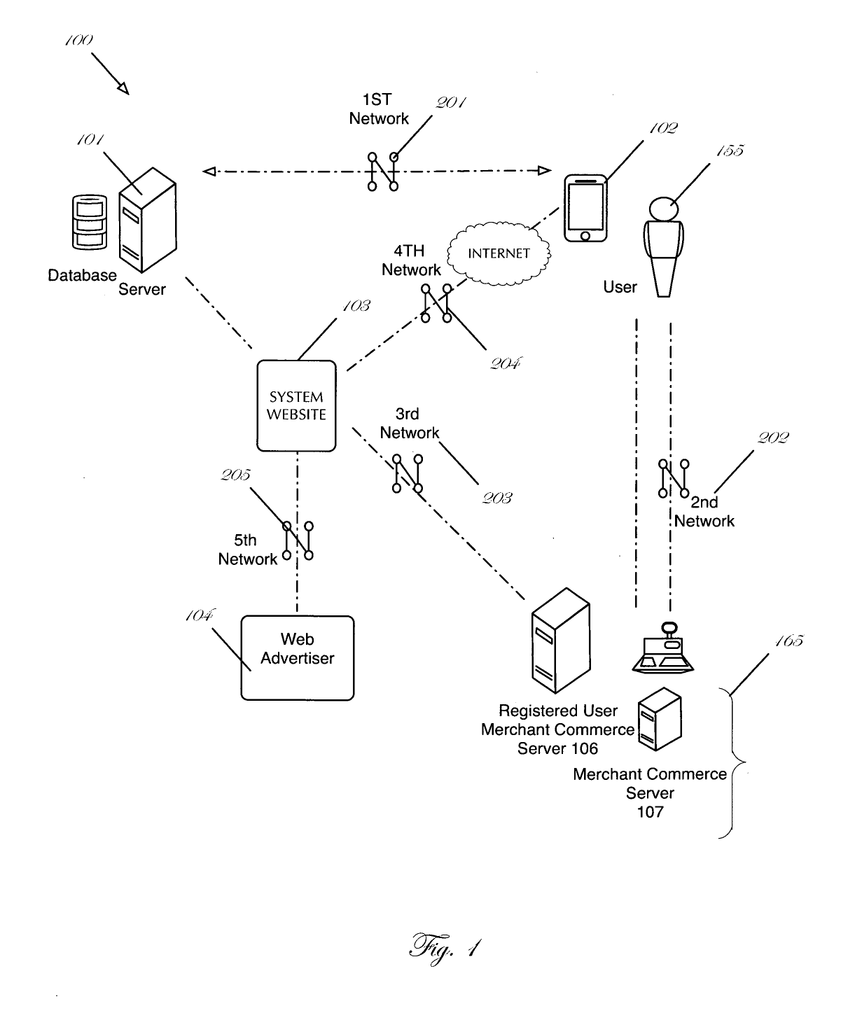

FIG. 1 illustrates a preferred embodiment of the present invention. The System 100 includes a mobile application 102, a server-database 101, and a system website 103. The mobile application is executable on a user's smartphone.

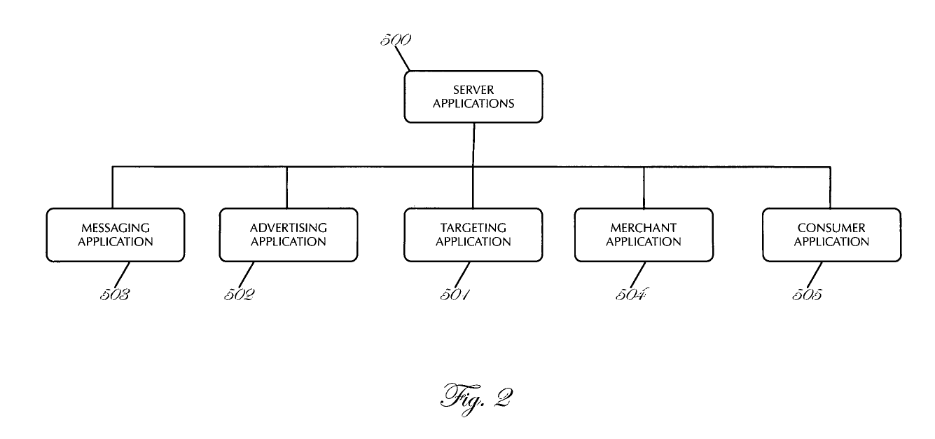

FIG. 2 illustrates that in some preferred embodiments, the system may further comprise a plurality of server applications 500. These server applications may comprise a targeting application 501, an advertising application 502, a consumer application 505, a messaging application 503, and a merchant application 504.

FIG. 1 illustrates that in some preferred embodiments, the System 100 is also operable on a plurality of networks. In some preferred embodiments, the System 100 runs on first network 201, a second network 202, a third network 203, a fourth network 204, and a fifth network 205.

The first network is in communication with the server-database assembly and the mobile application. The second network is in communication with the mobile application and a merchant. A manufacturer's coupon or merchant's transaction code can be used in the second network with the merchant whether the merchant is registered or not.

The third network is in communication with a system website 103 and a merchant registered with an advertiser a merchant account. The fourth network is in communication with a system website 103 and the mobile application. And the fifth network is in communication with the system website 103 and a web advertiser.

These networks may be local area networks, wide area networks, the Internet, mobile networks or other similar networks or combination of such networks. Collectively, or singularly, these network(s) may be a single network, or may be multiple networks. SMS messages may be sent from an application resident in a mobile device (upon which the mobile application operates) or from a PC application that is connected by a LAN to the internet.

The second network 202, is internet based or in proximity with the merchant. The second network is used to communicate between Mobile Application 102 and merchant. In some cases, a network may not be necessary since a registered customer can simply show the merchant their smart phone with the appropriate indicia transmitted therein.

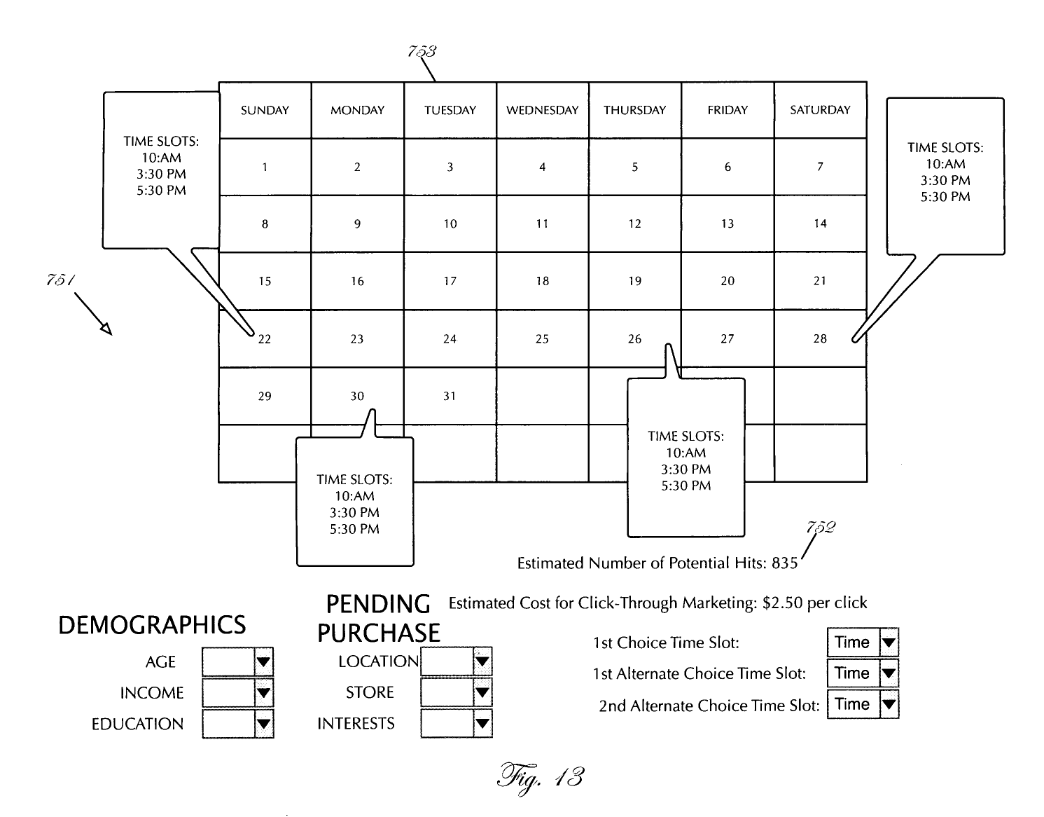

In operation, the customer tenders a promotional coupon signal (based on a code and instruction) that is provided by the Mobile Application 102 to the merchant or in order to complete the redemption part of the transaction as illustrated in FIG. 12. Upon completion of the transaction and acceptance of the coupon signal, the merchant may provide a receipt.

The third network 203, is internet or mobile device based that is used to communicate between the registered merchant (potential advertiser), and system server. In addition, a merchant connected to a local area network (LAN) which is connected to the network, or connected to the network through a large application service provider (ASP). A registered merchant 915 is interested in establishing promotional messages in the form of advertisements, discount coupon, or other notices. The network is the communication link to set up an account and protocols for the promotional messages to be sent to the Mobile Application 102.

The network can also establish a link for promotional messages from the Mobile Application 102 to be sent to the registered merchant. Such messages may be a merchandise order the merchant would process or an article of interest for which the Mobile Application 102 is soliciting.

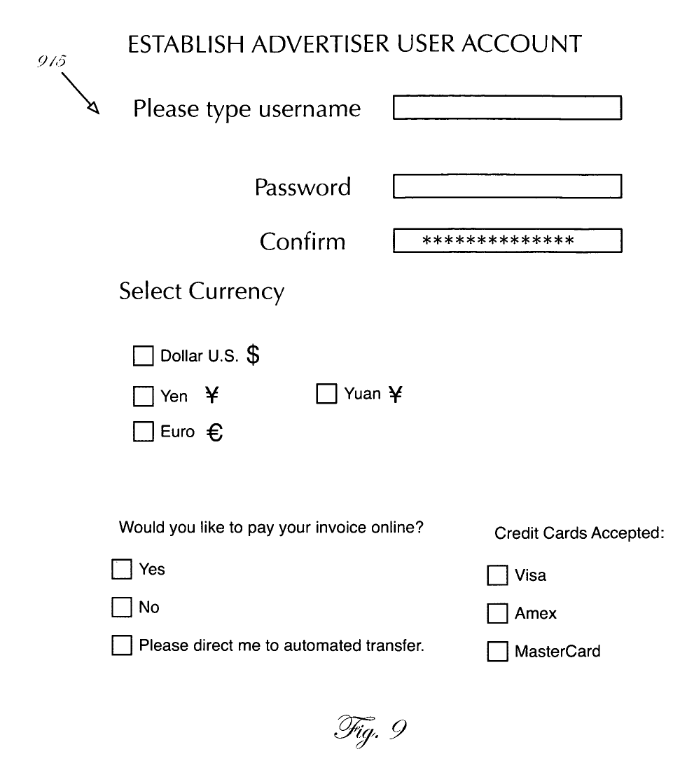

The fourth network 204, is Internet based that is used to communicate between the Mobile Application 102, and the system website ultimately connected to the commerce system server, for purpose of establishing or maintaining a user account 575 as illustrated in FIG. 8. The user account establishes the identity, security, interests, and other information of the consumer as illustrated in FIG. 5. The consumer can access transaction history via network.

The user account serves an important purpose as it collects various demographic information concerning each user. Demographic questions may range from a user's age, income level, education level, location of residence, etc. This data can provide a powerful value-added service to marketers. Customer can also disclose which products or services which are of interest to him or her.

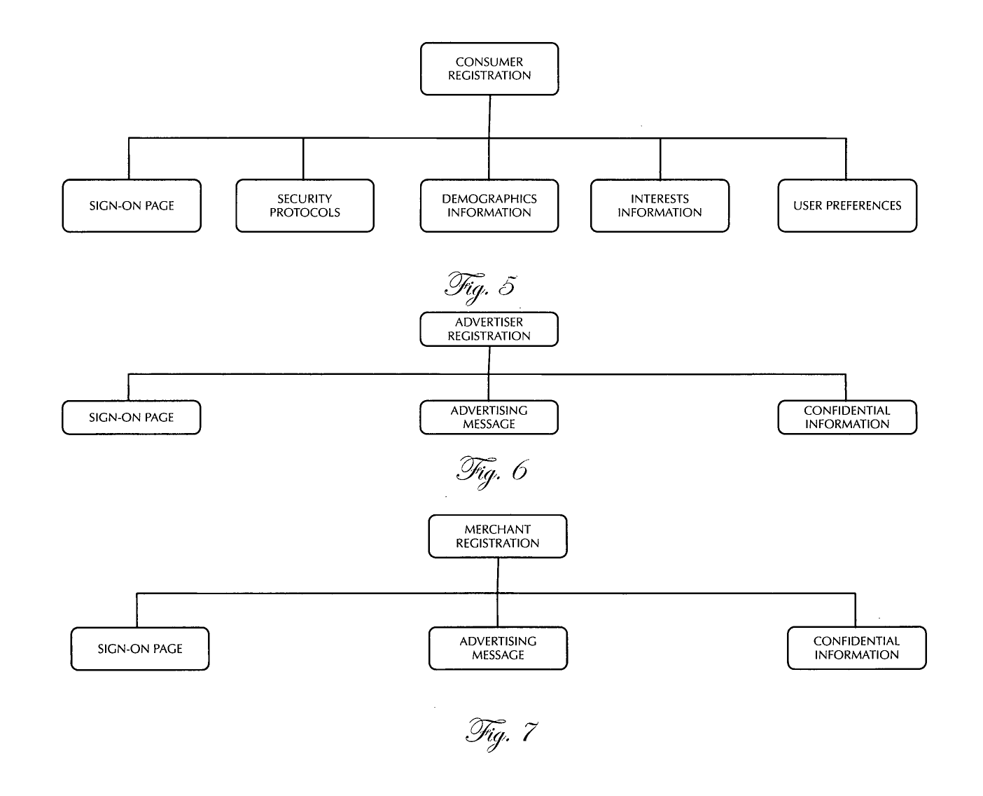

The fifth network 205, is internet based that is used to communicate between a web advertiser, and the commerce system server, for the purposes of establishing or maintaining an advertiser account 915. FIG. 6 illustrates that in some preferred embodiments, the advertiser account establishes the identity, security, and articles of commerce interest to be displayed on system website 103.

After the Mobile Application 102 has registered on the System 100, the Mobile Application 102 will need to be installed as an application on the customer's mobile device. The application controls the promotional messages to and from the System 100, the process to generate coupon code signals, signaling of the code to the merchant, the resources for searching stored information, and converting merchants signals (barcodes, RFID, IR) into numerical codes.

FIG. 12 illustrates that the mobile application is enabled to read and write bar code symbology such as QR Codes. The mobile application is enabled to capture images through the handset upon which it operates, encode, and decode those images.

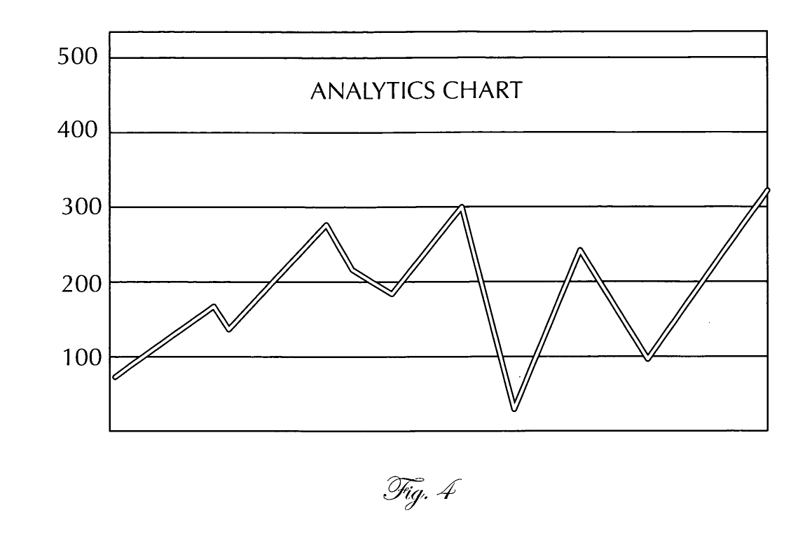

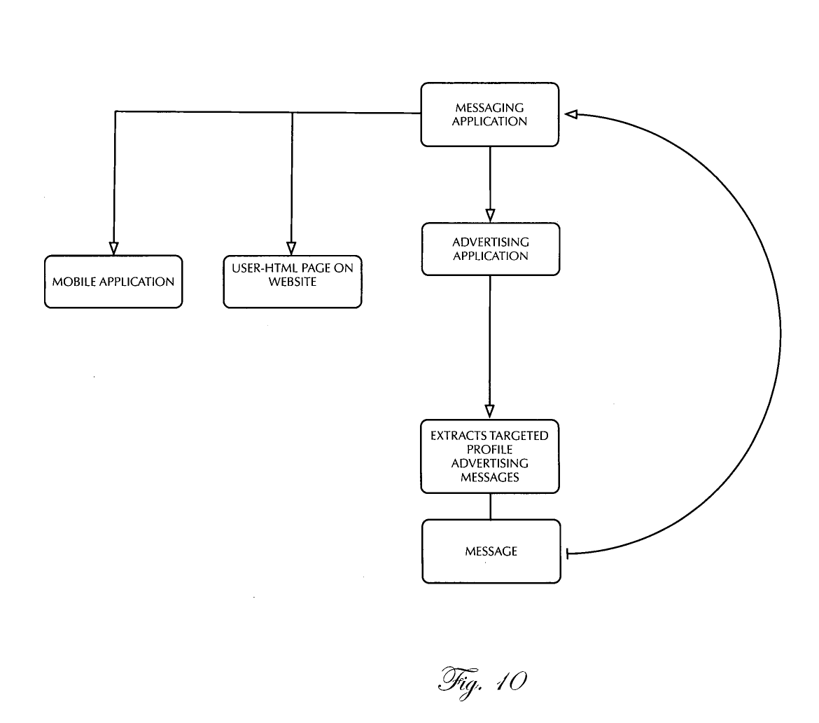

FIG. 9 illustrates that in some preferred embodiments, the advertiser account can also be used so that the advertiser can pay invoices online. Also, FIG. 4 illustrates that in some preferred embodiments, their accounts may enable them to track the performance of their advertising campaigns through various analytics software executable on the server-database. This tool can enable them to use various methods such as “split-testing”, A-B Testing, “dry-testing” etc., to fine-tune their advertising campaigns with extreme granularity.

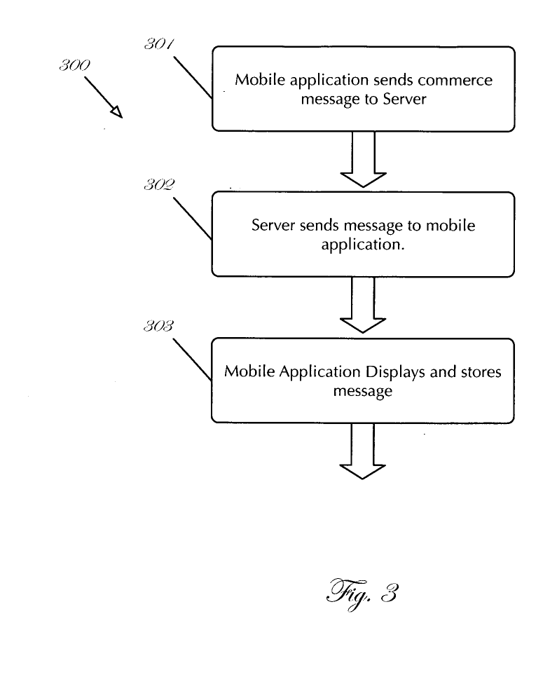

FIG. 3 illustrates a block diagram illustrating A Method for Mobile E-Commerce Marketing 300 through which the present invention operates. In step one 301, a commerce message (commerce transaction request via text, voice, or image) from the mobile application is sent to the system server 101 directly or indirectly through website 103.

In step two 302 a commerce message (pay code, confirmation or advertisement via text, image, or voice) from the commerce system server is sent to a consumer's mobile device. Delivery of the message is accomplished with the use of the mobile network message server system and other components. The merchant can scan the bar code on the user's mobile handset or can manually type in the settlement code.

In step three 303, the Mobile saves the display message.

The commerce demand requires the Mobile Application 102 to establish the identity of the merchant. A merchant registered with the System 100 will display a barcode readable by the mobile application on the customer's mobile device. The identity of the a non registered merchant is established by the store name and number, address, or other identification information. The user may select the merchant from the database.

In operation, a merchant may optionally choose to register with the System 100. However, in order for the merchant to have access to customer interests and to advertise to customers within the System 100, the merchant must be registered on the System 100.

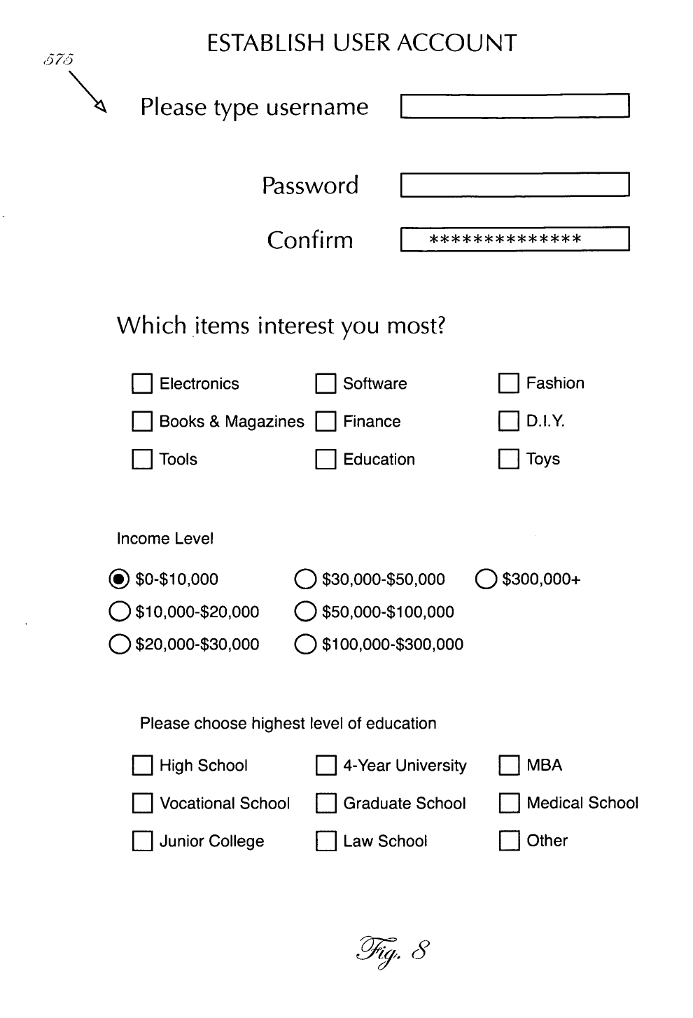

FIGS. 5-7 illustrate that in some preferred embodiments the registration is normally completed on a system website 103 over the internet network. The user registers on the system website 103 by submitting accurate identification information, security protocols within the parameters of the system website 103.

Consumer users provide information including personal identification, security protocols (account control), items of interest (goods and service desired), demographics, commerce preferences (advertisements not wanted). Both merchants and advertisers will provide business identification, advertising content, coupons, links, and target instructions. In addition, merchant users provide information for customer contact and services, currency for settlement.

The System 100 must review and approve the account as per various parameters including, but not limited to: credit rating, listing on Office of Foreign Assets Control (OFAC), etc. The System 100 may continue to evaluate the credibility of the user through various tests conducted on commerce messages, historical transactions on the system, or other appropriate reviews.

In some preferred embodiments the system will notify registered merchants, when a customer is in proximity of the merchant. The Mobile Application 102 will notify system of intent to purchase. This event is triggered when the mobile application transmits a signal to the System 100.

Upon receipt of the purchase intent by the mobile application the System 100 will create and transmit via SMS a promotional message and attendant coupon code and instruction by SMS. The coupon code is necessary for the Mobile Application to enable merchant to complete the transaction.

A merchant promotion message provides the merchant an opportunity to simply say “Welcome” or further to inform the

Consumer 155 of any specials. The Mobile Application 102 gives the user the option to skip over the advertisement, read it, save any coupons or details (website, UPC code) associated with advertisement, or follow a website link provided in the advertisement.

In operation, the merchant receives the coupon code by scanning the barcode signal or reception of a signal output by the customer's mobile device. The merchant's terminal is configured to recognize its own promotional codes and manufacturer's coupons. Signals are configured in form and format according to industry standard signals such as ISO IEC 15693 or 18000 for RFID signal or PDF 417 or Code 128 for a barcode.

In some preferred embodiments, the merchant may redeem the coupon code, and subsequently process the payment. Afterwards, the merchant tenders a receipt to the customer. Once the transaction is complete, a third party payment system can notify the System 100 of a completed transaction. After the System 100 is notified of completed transaction, a confirmation message and advertisement is sent via SMS to the Mobile Application 102. The advertisement is based on demographics location, time and/or interests.

FIG. 8 illustrates that the consumer application may host one or more system web pages that a consumer may browse using a consumer application to provide the consumer's mobile device address, demographic information, SMS message preferences and Notification and Advertisement Interest Categories that are stored in first database.

For example, the system website 103 may host a sign-on web page leading to consumer application. The system website 103 may be associated with a uniform resource locator (URL) that may be conveniently associated with the agent server. For example, the URL may be in the form “agent.com./agent-server.html” In this regard, sign-on web pages may be customized to each individual user, and may include products, services, logos, or other similar indicia.

In other words, each user may be given a separate html page such as “agent.com/jane-doe.html”. Web pages also may include web advertising data, such as web advertisement, which may be created by a web advertiser in accordance with this invention. It should be noted that merchant and web advertiser applications may host one or more web pages that a user may browse and create notification SMS messages.

Advertisers may select profiles of consumers who will receive such messages. For example, merchant application may be accessed via a sign-on web page.

The Sign-on web page may include a button for a person to begin registration and data entry sections for entering a username and password of a registered user. The user may provide this information using a keyboard, mouse, pointing device, or other similar data entry device included in or associated with merchant and web advertiser applications. After the user enters this information and clicks a submit button, merchant and web advertiser applications respectively verifies the entered information.

FIG. 9 illustrates that in some preferred embodiments, the username and password are correct, merchant and web advertiser applications may then display a business user profile page (e.g., address, phone and fax numbers, web site address, etc.) and business demographic information (e.g., food, clothing, entertainment, sports, etc.) for data entry, or edit by the administrative user.

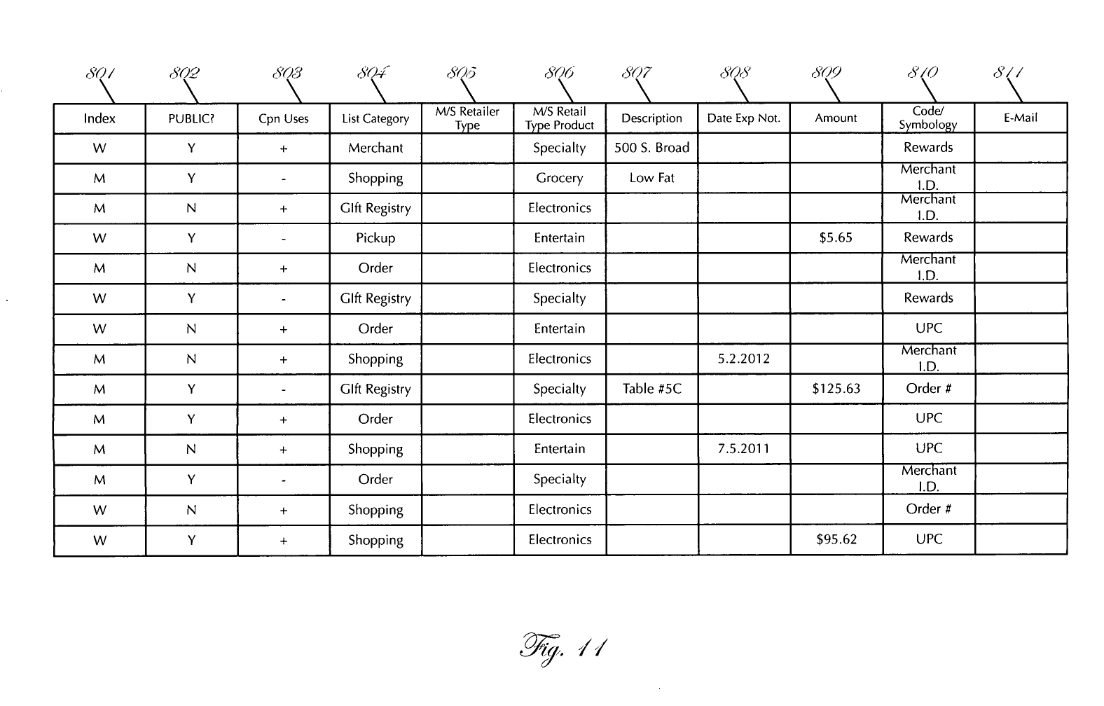

FIG. 9 illustrates that in some preferred embodiments, the authorized merchant or web advertisers may be directed to the message manager web page, an example of which is shown in FIG. 10. In particular, message manager web page may include a message entry section that a merchant or web advertiser may use to enter a notification message using advertising application. For example, a Marketing Officer may use a keyboard on web advertiser application to type a text notification message informing consumers that a coupon is available using a link. After completing the message, the web advertiser may then click the Save button to save the message to the agent server.

FIG. 13 illustrates that in some preferred embodiments, the merchant and web advertiser applications may include a consumer profile selection section that a user may use to specify a profile using targeting application. Targeting application may then display the corresponding Demographics and/or Notification Interest Categories that the merchant or web advertiser may select. The targeting application may omit the Interest Categories that the consumer identified as unavailable or private.

FIG. 13 illustrates that in some preferred embodiments, after the merchant or web advertiser specifies the profile, targeting application extracts from second database portion the User-Identification tags of the consumers who have identified the same Interest Category, and then displays a calendar showing timeslots that may be available for sending the advertising message. The targeting application may include in the calendar predictions of the number of consumers who match the specified profile and who may be available to receive such messages in each timeslot.

Timeslot selection web page may include a timeslot selection section that a merchant or web advertiser may use to select one or more timeslots for delivering the advertising message. For example, the web advertiser may select a first timeslot in first choice section and a second timeslot in second choice section. In addition, Timeslot selection web page optionally may include a section for specifying the total number of advertising messages to send during the selected timeslots.

Targeting application may then save the advertising profile in a database for execution at the time specified in the selected timeslots. FIG. 10 illustrates, in particular, when the current time equals the specified time, the advertising application is accessed by the messaging application in response to a commerce function.

FIG. 10 illustrates that in some preferred embodiments, the messaging application is executing a commerce function, the advertising application is extracting advertising messages eligible for the particular consumer based on a match of the consumer's Demographics and/or Interest Categories to the advertising profile. The advertising message is forwarded to the messaging application. The advertising message is incorporated into the format required of and combined with the commerce message to the consumer or html of the website.

The advertising application is updated reflecting the advertisement was sent. If the number of available matching User-Identification Tags was less than the total number of messages to be sent as specified by the merchant or web advertiser, targeting application may attempt to send the remaining number of messages during any selected subsequent timeslots.

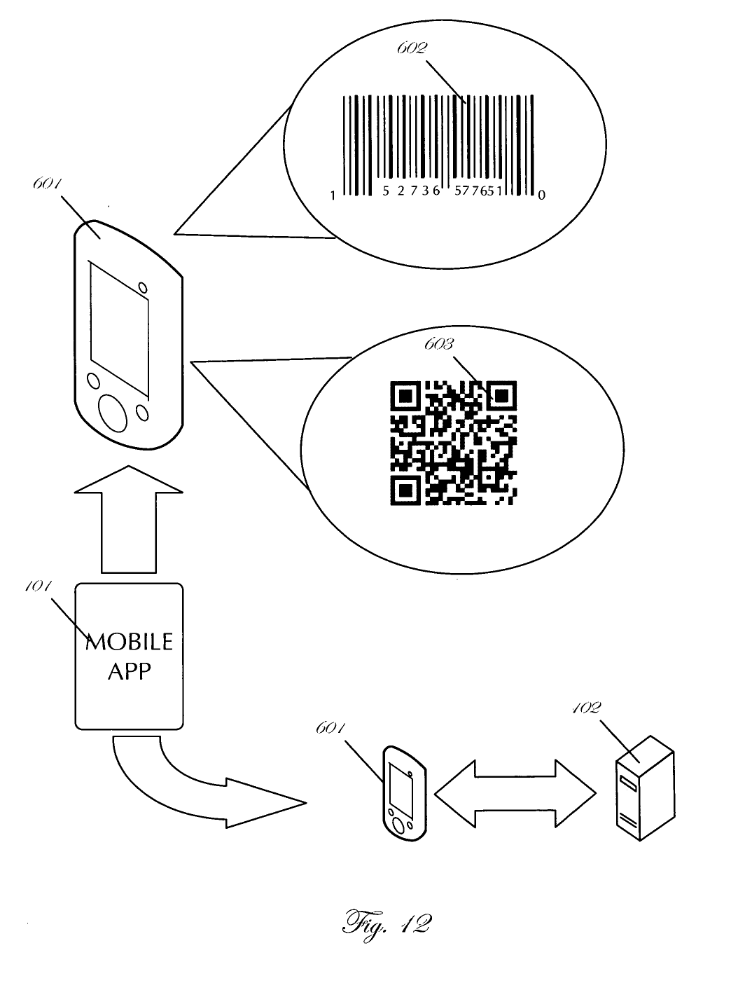

FIG. 11 illustrates that in some preferred embodiments, the server-database may operate a database. This database may be accessed by the consumer in order to aggregate various information and save that information on their handset for quick and easy accessibility. The information can be tabulated per a variegated set of controls to which the consumer has access.

The Public field 802 refers to whether the data list entry is available for view by a merchant or advertiser. Both A consumer's public and private information on the mobile device and agent server is available to that particular the consumer. Private information of an individual consumer is not available to merchants nor web advertisers, however the demographic and personal interests information of a plurality of registered consumers is available to merchants and web advertisers for targeting purposes. Public information comprising a specific purchase intent may be provided to a registered merchant at the time of a commerce demand by the registered consumer in proximity of a registered merchant.

The Coupon usage field 803 refers to coupons having restrictions on usage. This system will control the display of coupon codes for scanning purposes to conform to issuer's instructions. Coupon restrictions recognized, but not limited to, one use, one use per transaction, one use per day, etc.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A System for Marketing and Advertising through Mobile Electronic Commerce comprising: a mobile application executable on a mobile device, a server-database assembly, a plurality of server applications, and a system website;
the plurality of server applications includes a targeting application, a messaging application, an advertising application, a consumer application, and a merchant application.

2. The System for Marketing and Advertising through Mobile Electronic Commerce of claim 1 further comprising a first network, a second network, a third network, a fourth network, and a fifth network;
the first network is in communication with the server-database assembly and the mobile application;
the second network is in communication with the mobile application and a merchant;
the third network is in communication with a system website and a merchant registered with an advertiser account;
the fourth network is in communication with a system website and the mobile application;
the fifth network is in communication with the system website and a web advertiser.

3. The System for Marketing and Advertising through Mobile Electronic Commerce of claim 1 wherein the first network is SMS or mobile device based that is used to communicate between the registered consumer, and the system server.

4. The System for Marketing and Advertising through Mobile Electronic Commerce of claim 1 wherein the second network is used to communicate between Mobile Application and a merchant.

5. The System for Marketing and Advertising through Mobile Electronic Commerce of claim 1 wherein the third network is internet or mobile device based that is used to communicate between the registered merchant, and system server to establish and maintain a merchant account

6. The System for Marketing and Advertising through Mobile Electronic Commerce of claim 1 wherein the fourth network is internet based that is used to communicate between the Mobile Application, and the system website ultimately connected to the commerce system server, for purpose of establishing or maintaining a user account.

7. The System for Marketing and Advertising through Mobile Electronic Commerce of claim 1 wherein the fifth network is internet based that is used to communicate between a web advertiser, and the commerce system server, for the purposes of establishing or maintaining an advertiser account.

8. The System for Marketing and Advertising through Mobile Electronic Commerce of claim 1 wherein the advertiser account can also be used so that the advertiser can pay invoices online.

9. The System for Marketing and Advertising through Mobile Electronic Commerce of claim 1 wherein the mobile application is enabled to read and write bar code symbology such as QR Codes.

10. The System for Marketing and Advertising through Mobile Electronic Commerce of claim 1 wherein the system is capable of reviewing and approving an account as per various parameters.

11. The System for Marketing and Advertising through Mobile Electronic Commerce of claim 5 wherein the merchant can conduct commerce activities.

12. The System for Marketing and Advertising through Mobile Electronic Commerce of claim 1 wherein the merchant can target commerce messages, advertisements to consumers based on demographics, interests, time, and location.

13. The System for Marketing and Advertising through Mobile Electronic Commerce of claim 1 wherein the web advertiser can target commerce messages, advertisements to consumers based on demographics, interests, time, and location.

14. The System for Marketing and Advertising through Mobile Electronic Commerce of claim 1 wherein the system is capable of reviewing and approving commerce activities as per various parameters.
